(19) United States
(12) Patent Application Publication
(10) Pub. No.: US 2018/0199600 A1
(43) Pub. Date: Jul. 19, 2018

(54) COLORANT COMPOSITIONS CONTAINING C. TERNATEA DERIVED BOTANICAL EXTRACTS AND PROCESSES FOR THEIR PRODUCTION

(71) Applicant: Gold Coast Ingredients, Inc., Commerce, CA (US)

(72) Inventors: James Allen Sgro, Commerce, CA (US); Clarence Henry Brasher, Commerce, CA (US)

(21) Appl. No.: 15/865,969

(22) Filed: Jan. 9, 2018

Related U.S. Application Data
(60) Provisional application No. 62/446,068, filed on Jan. 13, 2017.

(51) Int. Cl. A23L 5/40; C09B 61/00; A23P 10/40

(52) U.S. Cl. CPC A23L 5/40; A23V 2002/00; A23P 10/40; C09B 61/00

(57) ABSTRACT

Compositions containing extract of C. ternatea flower and methods of extracting the extract and forming such composition are disclosed. Such compositions contain superior attributes as colorants, and may also include one or more of beta-carotene, beta-carotene extract, turmeric extract, or annatto extract and/or other suitable known colorants. Such compositions may be stabilized in a powder, crystal, or other solid form, or may be dissolved, suspended, or otherwise contained in solution. The extract may be produced via certain methods such as polar solvent extract, supercritical fluid extraction, expression, enfleurage, as well as other techniques. The stabilized compositions may further include a pH-modifying component for establishing or changing a pH level of a solution into which the composition is placed.

### CROSS-REFERENCE TO RELATED APPLICATIONS

This application relates to and claims the benefit of U.S. Provisional Application No. 62/446,068 filed Jan. 13, 2017 and entitled “COLORANT COMPOSITIONS CONTAINING C. TERNATEA DERIVED BOTANICAL EXTRACTS AND PROCESSES FOR THEIR PRODUCTION,” the entire disclosure of which is hereby wholly incorporated by reference.

### STATEMENT RE: FEDERALLY SPONSORED RESEARCH/DEVELOPMENT

Not Applicable

### BACKGROUND

### 1. Technical Field

The present disclosure relates generally to colorant compositions containing botanical extracts derived from C. Ternatea. More particularly, the present disclosure relates to processes for extracting botanical extracts from C. Ternatea and for producing novel colorant compositions therefrom having superior attributes, and to those novel colorant compositions.

### 2. Related Art

The plant Clitorea ternatea, a flowering vine native to Maritime Southeast Asia also variously called butterfly pea, Asian pigeonwings, bluebellvine, blue pea, and cordofan pea, has since antiquity been used in Southeast Asia and the Indian subcontinent for various purposes generally relating to its blue flowers, and specifically in relation to the color, flavor, and medicinal properties ascribed to the chemical compounds which may be extracted from those flowers according to various traditional processes or recipes.

For example, according to various traditional Southeast Asian recipes, C. ternatea flowers or aqueous extracts thereof are cooked with white rice in order to produce a blue-colored rice. C. ternatea flowers are also commonly used, alone or with other ingredients, to brew a blue-colored herbal tea.

One well-known and distinctive property of C. ternatea flower extract is its ability to serve as a natural pH indicator, in that it exhibits an especially vibrant and bright range of colors at different points of the pH spectrum. C. ternatea flower extract appears pink at pH 1, transitioning to violet at pH 4, to blue at pH 7, to olive green at pH 10, and to yellow at pH 14. This is generally understood to be a result of the unique combination of various anthocyanins along with other organic compounds and minerals in C. ternatea flower extract. This property has been exploited historically in Southeast Asian cuisine by adding an acidifying compound such as lemon or lime juice to C. ternatea extract tea, with the resulting color shift from blue to violet or pink providing an aesthetically pleasing visual surprise.

More recently, C. ternatea flower extract has found a worldwide market as a naturally-derived colorant for adding a vivid blue color to beverages. Many consumers prefer naturally-derived colorants over synthetic colorants, and it has been found that C. ternatea flower extract may serve as an effective naturally-derived substitute for commonly used synthetic blue colorants such as Brilliant Blue FCF (Blue No. 1), the colorant responsible for the blue color of the liqueur Blue Curacao, an ingredient in many blue-colored cocktails and other mixed drinks. Further, the pH-sensitive color shifting property of C. ternatea flower extract has been utilized as a visual novelty in the preparation of beverages according to a variety of schemes. For example, the C. ternatea flower extract may be frozen within ice cubes which are placed into an acidic beverage, resulting in the beverage undergoing an intense color shift as the ice cubes melt and release the C. ternatea flower extract.

In view of these uses, it may be seen that novel colorant compositions containing C. ternatea flower extract having superior attributes and novel processes for extracting C. ternatea flower extract and producing novel colorant compositions having superior attributes therefrom are desirable.

### BRIEF SUMMARY

To solve these and other problems, various novel colorant compositions containing C. ternatea flower extract and processes for producing such colorant compositions are contemplated.

The compositions may be, for example, including, but not limited to, compositions comprising C. ternatea flower extract and one or more of: beta-carotene, beta-carotene extract, turmeric extract, or annatto extract and/or other suitable known colorants. The compositions may be stabilized in a powder form, such as via partial evaporation of a solvent and dehydration or crystallization.

The compositions may further comprise one or more saccharides for heterogenous nucleation of the components of the C. ternatea flower extract. The saccharides may be chosen from the group of dextrose, maltodextrin, or combinations thereof and/or other suitable saccharides.

The compositions may also be stabilized in a solution, such as an 11% ethanol solution, a 51% glycerine solution, or a 25% propylene glycol solution.

The compostions may also be stabilized in a solid form other than a powder, such as a compressed or compacted material.

The C. ternatea flower extract may be extracted via use of an aqueous solvent. The C. ternatea flower extract may also be extracted and/or purified via another technique, such as via use of a polar solvent other than water, use of a nonpolar solvent, use of a combination of polar and nonpolar solvents, use of a distillation technique, use of a supercritical fluid extraction technique, use of an expression technique, or use or an enfleurage technique.

The composition may also further comprise one or more pH-modifying components for establishing or changing a pH level of a solution into which the composition is placed. The pH-modifying component may comprise a buffering agent and/or food grade organic or inorganic acids.

### DETAILED DESCRIPTION

According to one contemplated embodiment of the present disclosure, it is contemplated that an aqueous extract of C. ternatea flower may be stabilized in solution via the addition of one or more of: Ethanol, Glycerine, Propylene Glycol, Sodium Benzoate, Potassium Sorbate and/or food grade acids, Sugar, or via adjusting the pH content. In one embodiment, the aqueous extract of C. ternatea flower may be stabilized via placement into an 11% ethanol solution. It may also be seen that in other embodiments, the aqueous extract of C. ternatea flower may be stabilized via placement in a minimum 51% glycerine solution or a minimum 20% propylene glycol solution.

According to other embodiments, it is contemplated that an aqueous extract of C. ternatea flowers may be stabilized in a powder or other solid form via known techniques, such as partial evaporation of the aqueous solvent and subsequent dehydration or crystallization. According to various embodiments, it is contemplated that the processes for dehydration may include the addition of one or more saccharides such as dextrose or maltodextrin, which may serve various purposes, including but not limited to a filler-binder for the resulting powder or solid, or to aid in heterogeneous nucleation of the components of the aqueous extract of C. ternatea.

According to further embodiments, it is contemplated that extraction of the botanical extract from C. ternatea flowers may not necessarily be via an aqueous solvent process, but may be performed according to other known methods of extraction, including via other polar solvents than water, via nonpolar solvents, via combinations of polar and nonpolar solvents, or via other known extraction processes other than solvent extraction for extracting botanical extracts, including but not limited to distillation, supercritical fluid extraction, expression, or enfleurage techniques.

It may additionally be seen that the C. ternatea flower extract may be standardized across batches via adjustment of a number of factors, including adjustment of the amounts of the individual extract components, adjusting the temperature at which extraction is performed, adjustment of the pH of the extract in solution, or other methods.

It may further be seen that the C. ternatea flower extract may be compounded with other substances, including but not limited to extracts of other botanical substances. For example, it is contemplated that according to certain embodiments, the C. ternatea flower extract may be compounded with, for example, beta-carotene or beta-carotene-containing botanical extracts, turmeric extracts, or annatto extracts. It may further be seen that compounding of C. ternatea flower extracts with these aforementioned compounds or botanical extracts, and other compounds or botanical extracts, may impart or change various properties of the resulting C. ternatea flower extract-containing compositions from those understood to be present in a pure conventional C. ternatea flower extract. Such imparted or changed properties may include the colorant properties, the flavor properties, and the medicinal properties, among other properties. For example, it may be seen that the interplay between the pigmentation properties of the various components of a mixed C. ternatea flower extract-containing compositions may result in changes from the conventional C. ternatea flower extract color properties, both when held at constant pH levels and when the pH levels are altered.

According to one exemplary process for recovering the natural blue color from C. Ternatea, an extraction from the fresh or dried flowers (biomass) may be performed whereby the biomass is placed in contact with water, preferably at elevated temperature, to allow the color to dissolve away from the biomass and separate into the water. The biomass is separated from the solvent by physical means, and the solvent containing the color may be further processed to concentrate and stabilize the color. A counter current extraction may be performed where portions of fresh solvent are placed in contact with the biomass until most of the available color is removed. These washes may be recycled onto a fresh batch of the biomass to increase the concentration of the color in the individual wash portions, or the wash portions may be combined and some of the solvent removed via distillation to concentrate the color.

A preferred method of accomplishing such a current extraction is to use a vacuum soxhlet type extractor where the biomass is held in a porous container and fresh solvent (which in the preferred method is water) is distilled from the solvent reservoir, condensed above the porous container, and allowed to flow through the biomass before returning via a siphon to the solvent reservoir. This process allows exhaustive extraction of the biomass with smaller amounts of solvent, effectively concentrating the coloring material in the solvent. The use of a vacuum soxhlet extractor has the added advantage of minimizing exposure to heat, which can cause degradation of the color, while effectively concentrating the color from the biomass.

Water may be an effective solvent for the removal of the blue color from C. Ternatea, and indeed may be the preferred solvent where final application of the color is in foods and beverages, but it is not the only solvent that can be used. Other polar solvents, alone or in combinations, may be used.

A further advantage of a C. Ternatea extract is that it can be used in combination with natural yellow colorants (which may include turmeric extract, beta carotene, safflower extract, lutein, Marigold Extract, saffron extract, yellow gardenia and other permitted food colorants) to obtain various shades of green. Food and beverage manufacturers today are driven to replace synthetic colors with naturally derived food colorants. The most available “natural” green color is Chlorophyll, which is difficult to use in many applications due to stability issues related to pH, heat exposure, and light exposure. It is also known to give less vivid green colors.

Green colors based on C. Ternatea L. extract may be formulated which have advantages over Chlorophyll-based colors regarding heat and light stability. They may also be less susceptible to pH stability issues than Chlorophyll. Finally, they may produce more vivid shades of green depending on the application conditions.

What is claimed is:

1. A composition comprising:
C. ternatea flower extract; and
one or more of: turmeric extract, beta carotene, beta-carotene extract, safflower extract, lutein, Marigold Extract, saffron extract, yellow gardenia, turmeric extract, annatto extract.

2. The composition of claim 1, wherein the composition is stabilized in a powder form.

3. The composition of claim 2, wherein the composition is stabilized in a powder form via partial evaporation of a solvent and dehydration.

4. The composition of claim 2, wherein the compositions is stabilized in a powder form via partial evaporation of a solvent and crystallization.

5. The composition of claim 3, wherein the composition further comprises one or more saccharides for heterogeneous nucleation of the components of the C. ternatea flower extract.

6. The composition of claim 5, wherein the one or more saccharides are chosen from the group of: dextrose, maltodextrin, or combinations thereof.

7. The composition of claim 1, wherein the composition is stabilized via placement into an 11% ethanol solution.

8. The composition of claim 1, wherein the composition is stabilized via placement into a 51% glycerine solution.

9. The composition of claim 1, wherein the composition is stabilized via placement into a 25% propylene glycol solution.

10. The composition of claim 1, wherein the composition is stabilized in a solid form.

11. The composition of claim 1, wherein the C. ternatea flower extract is extracted via use of an aqueous solvent.

12. The composition of claim 1, wherein the C. ternatea flower extract is extracted via use of a polar solvent other than water.

13. The composition of claim 1, wherein the C. ternatea flower extract is extracted via use of a nonpolar solvent.

14. The composition of claim 1, wherein the C. ternatea flower extract is extracted via use of a combination of polar and nonpolar solvents.

15. The composition of claim 1, wherein the C. ternatea flower extract is extracted and purified via distillation.

16. The composition of claim 1, wherein the C. ternatea flower extract is extracted via a supercritical fluid extraction technique.

17. The composition of claim 1, wherein the C. ternatea flower extract is extracted via an expression technique.

18. The composition of claim 1, wherein the C. ternatea flower extract is extracted via an enfleurage technique.

19. The composition of claim 1, further comprising a pH-modifying component for establishing or changing a pH level of a solution into which the composition is placed.

20. The composition of claim 19, wherein the pH-modifying component comprises a buffering agent.
